(19) United States
(12) Patent Application Publication
(10) Pub. No.: US 2013/0282307 A1
(43) Pub. Date: Oct. 24, 2013

(54) TURBO-MACHINERY STAGE FAMILIES TUNING/CALIBRATION SYSTEM AND METHOD

(71) Applicants: Omar Mohamed El Shamy, Doha (QA); Nidal Awni Ghizawi, Doha (QA); Denis Guillaume Jean Guenard, Florence (IT); Vittorio Michelassi, Florence (IT); Sivasubramaniyan Sankaran, Bangalore (IN); Clary Susanne Ingeborg Svendotter, Le Creusot (FR)

(72) Inventors: Omar Mohamed El Shamy, Doha (QA); Nidal Awni Ghizawi, Doha (QA); Denis Guillaume Jean Guenard, Florence (IT); Vittorio Michelassi, Florence (IT); Sivasubramaniyan Sankaran, Bangalore (IN); Clary Susanne Ingeborg Svendotter, Le Creusot (FR)

(73) Assignee: NUOVO PIGNONE, S.P.A., Florence (IT)

(21) Appl. No.: 13/806,597

(22) PCT Filed: Jun. 22, 2010
(86) PCT No.: PCT/EP10/58859

§ 371 Date: Jun. 6, 2013

(51) Int. Cl. G06F 17/50

(52) U.S. Cl. CPC G06F 17/5086
USPC 702/33

(57) ABSTRACT

System and method for automatically determining a final set of tuning/calibration parameters for designing a new turbo-machinery. The method includes inputing an initial set of tuning/calibration parameters; calculating family turbo-machinery quantities based on the initial set of tuning/calibration parameters; comparing the calculated family turbo-machinery quantities with measured quantities and calculating a first error between the calculated family quantities and the measured quantities; calculating a second error between the initial set of tuning/calibration parameters and default values of the turbo-machine variables; forming a modified objective function that includes both the first and second errors; during an iterative process, varying the initial set of tuning/calibration parameters in such a way that the final set of tuning/calibration parameters is found; and storing in a database the final set of tuning/calibration parameters for the family.

### BACKGROUND OF THE INVENTION

Embodiments of the subject matter disclosed herein generally relate to methods and systems and, more particularly, to mechanisms and techniques for tuning/calibrating turbo-machinery stage families.

One type of turbo-machinery is a centrifugal compressor. Centrifugal compressors are usually designed in families intended to cover a specific flow range and use. A centrifugal compressor can have one or several stages. Each individual design within the family may be of different size and may have a varying number of blades in the impeller (e.g., splitter or non-splitter in one or multiple rows), statoric parts (e.g., return channel with vanes, one or multiple rows with splitter or cascade vanes or wedge type vanes), a diffuser (e.g., with airfoil of low solidity or cascade or wedge type with one or multiple rows of vanes or without vanes), and an exit system (e.g., scroll, collector, deswirl), etc. The individual designs in a family stretch from low to high design flow coefficients and sometimes from low to high design Mach numbers. Each family member is defined with one design flow coefficient and speed, but also with a useable flow range and speed range, as shown in FIG. 1. The family shown in FIG. 1 includes four designs, each one with its design speed line 2, 4, 6, and 8 and several additional speed lines. In total there are twelve speed lines to be used in the calibration/tuning of the 1-D models with respect to the polytropic efficiency and head for this specific example. It is noted that all values in FIG. 1 are normalized to a corresponding value at a medium-high design flow rate. A chosen number of the designs (called test masters and shown as elements 10 in FIG. 2) are selected for testing and then tuned/calibrated to test data. The tuned/calibrated test masters 10 are saved as database masters, which in turn are used to populate the design database, which is schematically illustrated in FIG. 2. The other design points 12 are not tested. However, these points are also stored in the design database and these points correspond to already designed compressors. When a customer orders a new compressor having the design indicated by point 14 in FIG. 2, which does not exist in the design database, the test masters and the designed points may be used to model the desired compressor, e.g., determine the design parameters.

Optimization strategies have been used in recent years for the aerodynamic and mechanical design of turbo-machine components. In particular, numerical optimization techniques seem to be one of the most promising tools for the aerodynamic design of new generation turbomachinery components (Bonaiuti et al., “Analysis and Optimization of Transonic Centrifugal Compressor Impellers Using the Design of Experiments Technique”, Journal of Turbomachinery, 128(4), pp. 786-797, 2006, the entire content of which is incorporated herein by reference).

An aero design cycle of centrifugal compressor stages starts with a 1-D performance prediction and calculation process followed by detailed design, analyses and tests to validate the prediction. A part of the design process is the 1-D performance parameters prediction and calculation. This task is carried out with the help of a 1-D performance prediction tool, which calculates, for example, a polytropic head, polytropic efficiency, work coefficient etc. of the compressor. The flow models in the 1-D tool needs need to be adjusted by means of so called tuning/calibration coefficients in order to fit as close as possible to test data. High accuracy and predictability of the 1-D tool is desired and continuous improvements are performed to have a better prediction tool with minimal deviation from experiment. Fleet feedback and reports are effectively utilized in developing correlations for better predictability.

Presently, the tuning process of the 1-D tool is a manual process. This process utilizes data from the tests conducted for different stages together with a limited, small, number of tuning parameters.

For example, centrifugal compressors are usually designed in families intended to cover a specific flow range and use. FIG. 3 illustrates families 20, 22, 24, 26, and 28 having different geometric characteristics (represented as polygons). The graph of FIG. 3 classifies the various compressors based on a design peripheral Mach number versus flow coefficient. The Mach number represents the speed of the medium (being compressed by the compressor) relative to speed of sound and the flow coefficient indicates the amount of medium flowing through the compressor. Individual designs in a family cover a range of flow coefficients and often multiple speed lines (i.e., different Mach numbers). Each family member may be characterized by a design flow coefficient and a speed, the so called design point, but its calibration/tuning parameters are usable in the family flow range and speed range (a range of several operating points). A database may be used to store representative points per families indexed according to flow coefficients and Mach numbers.

In addition, tuning/calibration parameters that prove effective for one particular stage may not be suitable for another stage. The more the performance indices need to be optimized, the higher the number of iterations required by the user to reach an acceptable, although not necessarily optimum, level of improvement with respect to the baseline, where the baseline may be represented by default tuning/calibration parameter values. The number of tuning/calibration parameters affects the optimization process as a small increase of the number of tuning/calibration parameters leads to a rapid increase in the number of iterations needed.

An optimization procedure handling the geometrical design features of the centrifugal compressors has already been developed (see for example, Omar et al. “An Aerodynamic Optimization Procedure for Preliminary Design of Centrifugal compressor stages”, GT2008-51154, ASME Turbo Expo 2010, the entire content of which is incorporated herein by reference). This optimization procedure is intended for the preliminary design of the centrifugal compressor stages. An effectiveness of this optimization algorithm may be limited as the flow models in the 1-D performance prediction tool needs to be calibrated with test data in order to be able to estimate the expected flow behavior through the compressor stage. Considering the dependability of other tools on the predictability of 1-D tool, it may be desirable to develop an automated optimization algorithm that matches the 1-D tool with respect to the experiment results.

### BRIEF DESCRIPTION OF THE INVENTION

According to one exemplary embodiment, there is provided a method for automatically determining a final set of tuning/calibration parameters for designing a new turbo-machinery. The method comprises inputting an initial set of tuning/calibration parameters; calculating family turbo-machinery quantities based on the initial set of tuning/calibration parameters; comparing the calculated family turbo-machinery quantities with measured quantities and calculating a first error between the calculated family quantities and the measured quantities; calculating a second error between the initial set of tuning/calibration parameters and default values of the turbo-machine variables; forming a modified objective function that includes both the first and second errors; during an iterative process, varying the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and storing in a database the final set of tuning/calibration parameters for the family.

According to another exemplary embodiment, there is provided a design apparatus for determining a final set of design parameters for a new turbo-machinery. The design apparatus comprises an interface configured to input an initial set of tuning/calibration parameters; and a processor connected to the interface. The processor is configured to calculate family turbo-machinery quantities based on the initial set of tuning/calibration parameters; compare the calculated family turbo-machinery quantities with measured quantities and calculate a first error between the calculated family quantities and the measured quantities; calculate a second error between the initial set of tuning/calibration parameters and default values of the turbo-machine variables; form a modified objective function that includes both the first and second errors; vary, during an iterative process, the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and store in a database the final set of tuning/calibration parameters for the family.

According to yet another exemplary embodiment, there is provided a computer readable medium comprising computer executable instructions, where the instructions, when executed, implement the method discussed above.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an example of a family to be used for designing another turbo-machine;

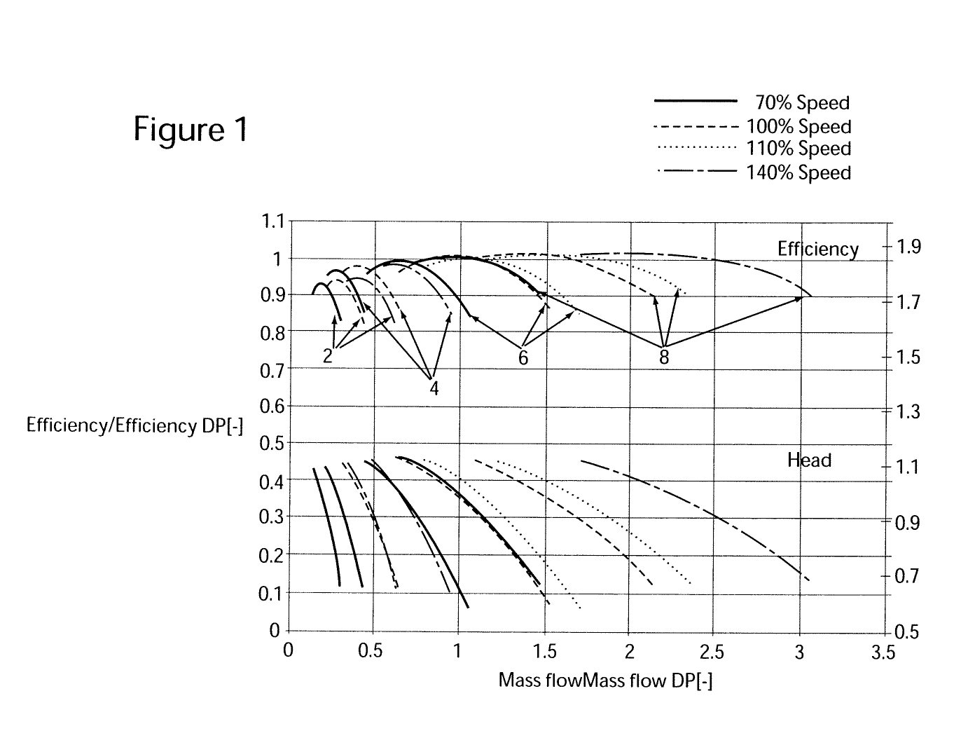

FIG. 2 is a schematic diagram of a family of turbo-machines categorized by Mach number and flow coefficient;

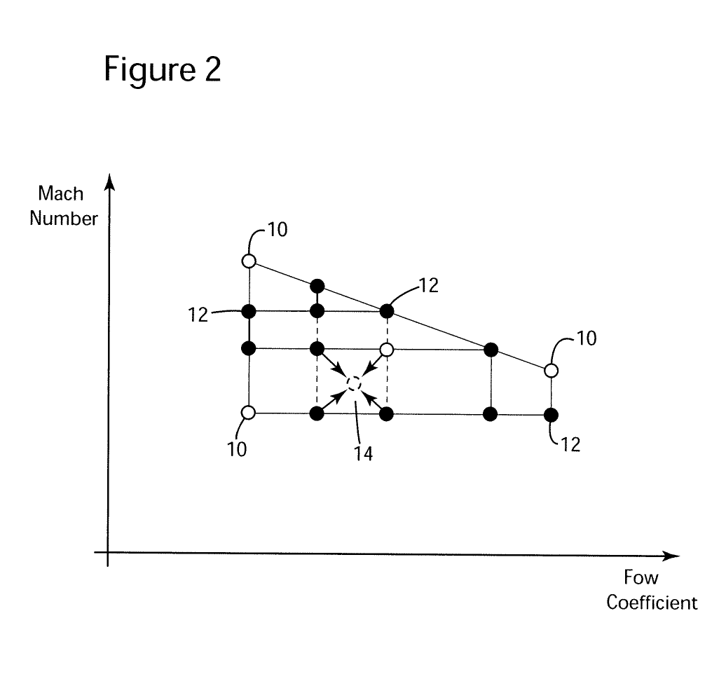

FIG. 3 is a schematic diagram of multiple families of turbo-machines categorized by Mach number and flow coefficient;

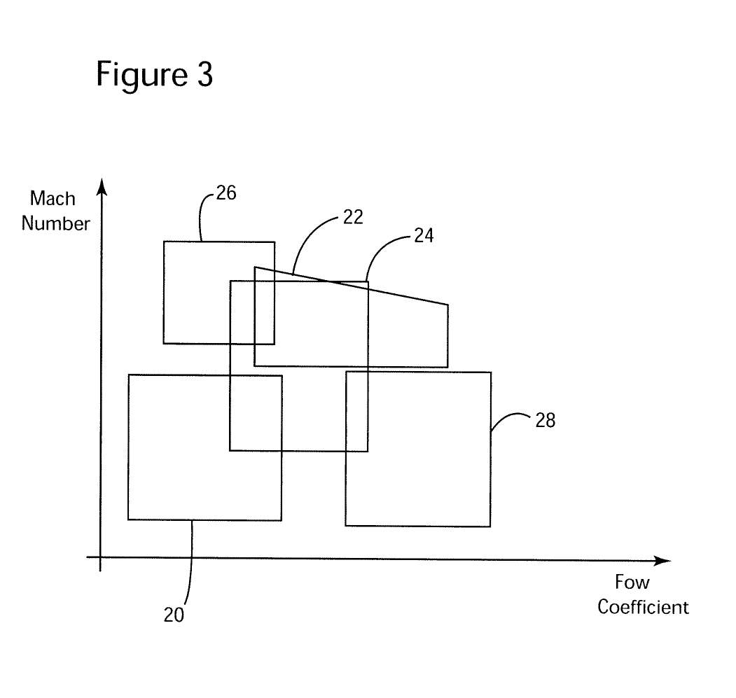

FIG. 4 is a graph illustrating a polytropic efficiency versus flow for a compressor family;

FIG. 5 is a graph illustrating a polytropic head versus flow for a compressor family;

FIG. 6 is a flowchart illustrating an algorithm for calculating design parameters for a new turbo-machinery according to an exemplary embodiment;

FIG. 7 is a graph illustrating measured points of a family of compressors relative to an estimated curve for the same family according to an exemplary embodiment;

FIG. 8 is a graph illustrating design point conditions and off-design conditions for a compressor family according to an exemplary embodiment;

FIG. 9 is a graph illustrating design parameters manually (and for one family member at a time) and automatically tuned for a compressor family according to an exemplary embodiment;

FIG. 10 is a graph illustrating an automatically tuned polytropic efficiency and head versus a manually tuned/calibrated one for a compressor family member according to an exemplary embodiment;

FIG. 11 is a graph illustrating smoothly tuned design parameters for a compressor family according to an exemplary embodiment;

FIG. 12 is a schematic diagram of a design apparatus according to an exemplary embodiment;

FIG. 13 is a flow chart illustrating a method for calculating design parameters according to an exemplary embodiment; and

FIG. 14 is a schematic diagram of a centrifugal compressor.

### DETAILED DESCRIPTION OF EXEMPLARY EMBODIMENTS OF THE INVENTION

The following description of the exemplary embodiments refer to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of centrifugal compressors. However, the embodiments to be discussed next are not limited to these systems, but may be applied to other systems, for example other types of compressors or other turbo-machines like steam turbines, gas turbines etc., that use 1D performance prediction tool for the initial performance prediction.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Some terminology to be used to describe the exemplary embodiments is discussed next. While the following terms are understood as defined below, it is noted that those skilled in the art may use similar terms for the same quantities. Calibration/tuning parameters/variables are coefficients used to adjust the 1D flow model in order to fit it as close as possible to test data. Design variables are variables defining the geometric design of the compressor. Operating parameters/variables are parameters determining the functioning of the compressor (e.g., gas quantities, mass flow, rotational speed, pressure ratio, temperature, etc.). A design point includes a set of flow conditions (e.g., gas quantities, mass flow, rotational speed, pressure ratio, temperature, etc.) for which the compressor has been designed. An operating point includes one or several sets of flow conditions at which the compressor will be used (e.g., gas quantities, mass flow, rotational speed, pressure ratio, temperature, etc.). The operating point may or may not be the same as the design point.

The following quantities are also defined.

Flow coefficient:

$$ϕ = \frac{\dot{Q}}{4 π {D}_{2}^{2} {U}_{2}}$$

Polytropic efficiency:

$${η}_{p} = \frac{γ - 1}{γ} \frac{ln ( {p}_{0 o} \text{/} {p}_{0 i} )}{ln ( {T}_{0 o} \text{/} {T}_{0 i} )}$$

Polytropic head rise:

$${Ψ}_{total} = \frac{g ( {H}_{0 o} - {H}_{0 i} )}{{U}_{2}^{2}} = {τη}_{p}$$

Work coefficient:

$$τ = \frac{{h}_{0 o} - {h}_{0 i}}{{U}_{2}^{2}}$$

D₂=Impeller blade tip diameter

g=Gravity constant [m/s₂]

H₀ₒ=Head at stage exit [m]

H₀ᵢ=Head at stage inlet [m]

h₀ₒ=Total enthalpy at stage exit [J/kg=m₂/s₂]

h₀ᵢ=Total enthalpy at stage inlet [J/kg=m₂/s₂]

P₀ᵢ=Total pressure at stage inlet [Pa]

P₀ₒ=Total pressure at stage exit [Pa]

\dot{Q}=Mass flow [kg/s]

T₀ᵢ=Total temperature at stage inlet [K]

T₀ₒ=Total temperature at stage exit [K]

U₂=Impeller blade tip speed [m/s], and

γ=Ratio of specific heat capacities.

According to an exemplary embodiment, an optimization algorithm may interface an optimization tool with a 1-D prediction tool for providing a best possible solution within given tuning/calibration limits. The automated optimization algorithm may improve the predictability of the 1-D tool when used for the development of centrifugal compressor stages or other turbo machines. The 1-D tuning/calibration parameters are predicted in alignment with the experiment and then these parameters are used to perform subsequent 2-D and 3-D design phases. In one application, the optimization algorithm starts with one set of tuning/calibration parameters. These can be either default values, taken from a similar family of turbo-machines or chosen from within a pre-determined range. The algorithm then calculates various quantities of the machine and compares two errors (to be described later). Then, the algorithm re-run the calculations while varying the tuning/calibration parameters within a pre-determined range until a minimum error is found. An additional constraint may be imposed on the algorithm and this is that for all the design operating points included in the optimization, a smoothness between the tuning/calibration parameters needs to be found. In other words, the optimization works as a calibration in two dimensions, operating points on one axis and tuning/calibration parameters on the other. Together they define the performance result, which is desired to have a minimal deviation from the measured results. At the same time, each tuning/calibration parameter is desired to be smooth over the operating points range.

The 1-D tool is capable of computing, based on a given geometric outline of a stage of a compressor and operating conditions (e.g., inlet pressure and temperature, mass flow, rotation speed, gas properties, etc.), quantities such as polytropic efficiency, polytropic head, work coefficient, pressure ratio, surge, choke limits, etc. The geometry taken into consideration may include an impeller, a diffuser, and an exit system but a wide variety of components may be used including, but not limited to, Inlet Guide Vane, impeller (Splitter or Non Splitter in one or multiple rows), statoric parts (return channel with vanes (one or multiple rows) with splitter or cascade vanes or wedge type vanes), diffuser (with airfoil of low solidity or cascade or wedge type with one or multiple rows of vanes or without vanes), exit system (scroll, collector, deswirl), etc.

For each component type, the user may be requested to provide the geometrical data defining its outline (e.g., meridional and blade-to-blade). These parameters may be provided to an input file. The results of the calculation may be stored in an output file in which the results may be presented in modules repeated for all design and off-design conditions. By applying the prediction tool to this geometry, the associated performance parameters can be extracted from the corresponding output file.

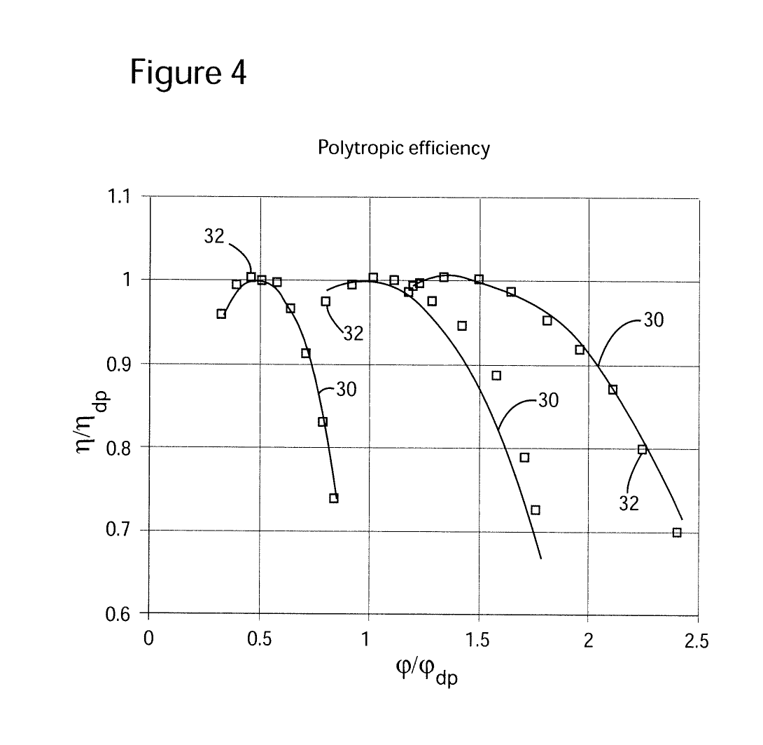

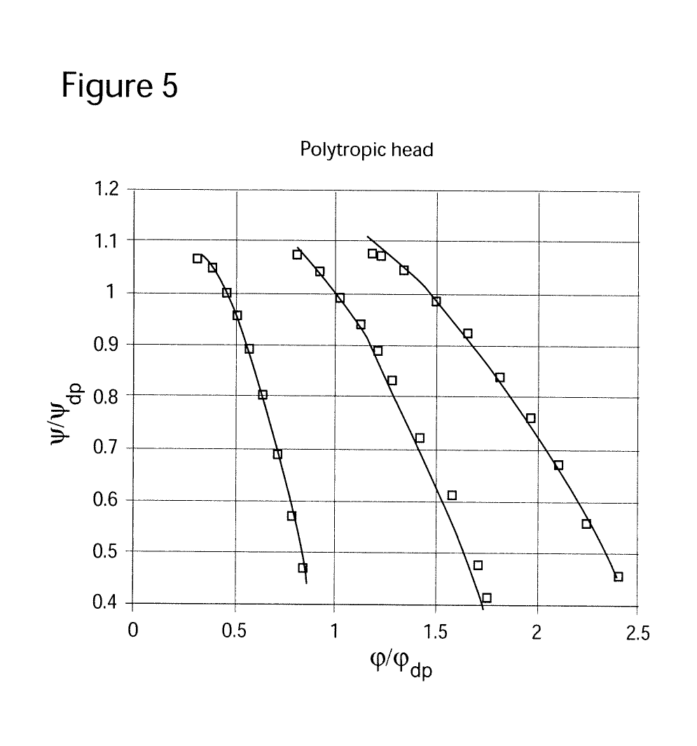

An experimental validation of the prediction tool for an existing stage design indicates the relevance of family tuning/calibration. For example, FIG. 4 shows a comparison between predicted values (lines 30) and tested values (points 32). Normalized polytropic efficiency is plotted versus the flow coefficient normalized by the design flow coefficient of medium flow coefficient stage. FIG. 5 shows a similar comparison for a polytropic head versus the flow coefficient normalized by the design flow coefficient of medium flow coefficient stage. It can be seen from FIGS. 4 and 5 that family tuning/calibration does not necessarily mean an optimal tuning/calibration for all the individual family members as an objective is to find an optimal overall match.

In the traditional tuning/calibration, the main effort is put on the design point, which is tuned mainly with two factors related to the efficiency and the impeller exit flow angle. The intention in the traditional tuning is to match the polytropic efficiency and head as close as possible. Impeller inlet loss models are then modified, by means of two coefficients working on the inlet flow, to improve choke and stall limits. All these steps are performed individually for each design flow coefficient stage. The shape of the performance curve is not necessarily followed.

Variations in speed ratio for each design flow coefficient are usually not tuned/calibrated but only checked. Once all designs have been tuned/calibrated, the resulting parameters are compared and some of them are adjusted. It is desired to have a smooth development parameter value with design flow coefficients within the family. In one application, three additional tuning/calibration parameters were used (associated with flow separation, flow blockage and critical Mach number) in order to also tune/calibrate the shape of the performance curves. However, such a manual tuning/calibration process, for example, for a family with six members and seven tuning parameters takes nearly two months when performed by an experienced engineer. Even then it is not certain that the true optimal calibration/tuning has been achieved, since a manual tuning/calibration is performed only until an acceptably good match has been found.

According to an exemplary embodiment, a novel optimization algorithm (from here on referred to as “the optimizer”) is capable of tuning/calibrating the entire centrifugal compressor stage family with ‘n’ number of speed lines in both design and off-design conditions in one run. The optimizer may handle all the centrifugal compressor stage types and masters of different mass flows having the same design peripheral Mach number. Input details for the optimizer may be files defining the stage parameters and corresponding experimental data for all the stages that are to be tuned/calibrated. The optimizer is flexible enough to be used both for the tuning/calibration of a single stage and for the entire centrifugal compressor stage family including “n” number of stages (called masters) that are tested and their performance stored in a database. The optimizer can handle any number of tuning/calibration variables during one run. One objective of the optimizer is “minimizing” an RMS (root mean square) value of an error between test and predicted values. The error as stated here may include two components, a first component indicating how far a predicted/calculated point deviates from experimental data (the Error component), and a second component indicating how much the calibration/tuning variable/parameter deviates from a default value as specified by the user (the Devi component). The default values may be found in open literature or in in-house design practices.

The two error components may be weighted with variable weights by means of a W_devi factor as specified by the user. Also, each test point may be given an individual weight by the user, so that for example, the design point can be heavier weighted that the other points. One advantage of this algorithm that aids in accurate optimization is that each point may be handled individually.

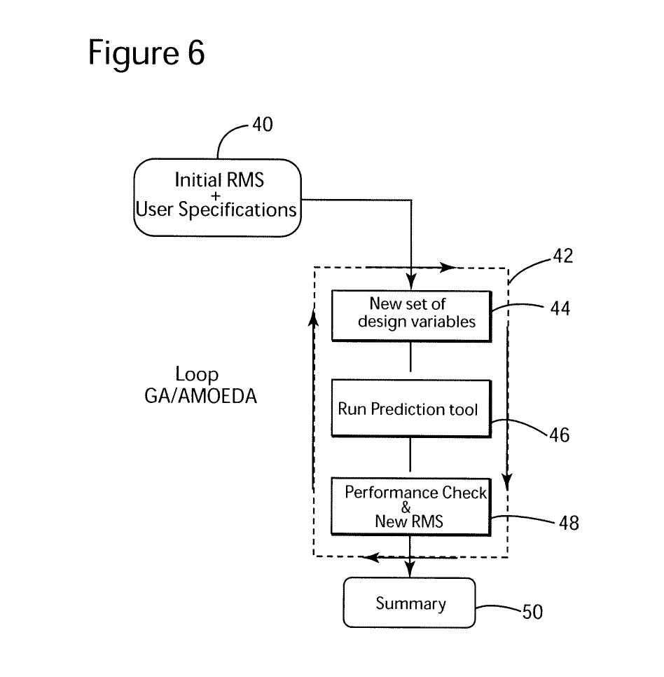

FIG. 6 is a diagram illustrating the optimization process according to an exemplary embodiment. In step 40, an objective function (to be discussed later) and constraints are defined based on user input values. A modified objective function (OFMOD) is calculated. The modified objective function is discussed in more details later. Then, in the optimization loop 42, the optimizer determines in step 44 an initial/new set of tuning/calibration parameters. Conditions associated with the initial set of tuning/calibration parameters are also discussed later. The algorithm uses the 1-D prediction tool in step 46 to predict the performance (i.e., quantities as polytropic head, polytropic efficiency and work coefficient) of the compressor by using the new set of tuning/calibration variables. This step may involve calculating the two error components. The performance of the compressor is checked and a new objective function value is computed in step 48. Then, the algorithm may be repeated using a different set of tuning/calibration variables until a desired final set is achieved. The final set of tuning/calibration variables achieves (1) a best fit between the family of turbo-machinery quantities and measured quantities, and (2) a smooth transition for the final set of tuning/calibration parameters from one member to another member of the family. A summary 50 of the analysis may be presented to the user.

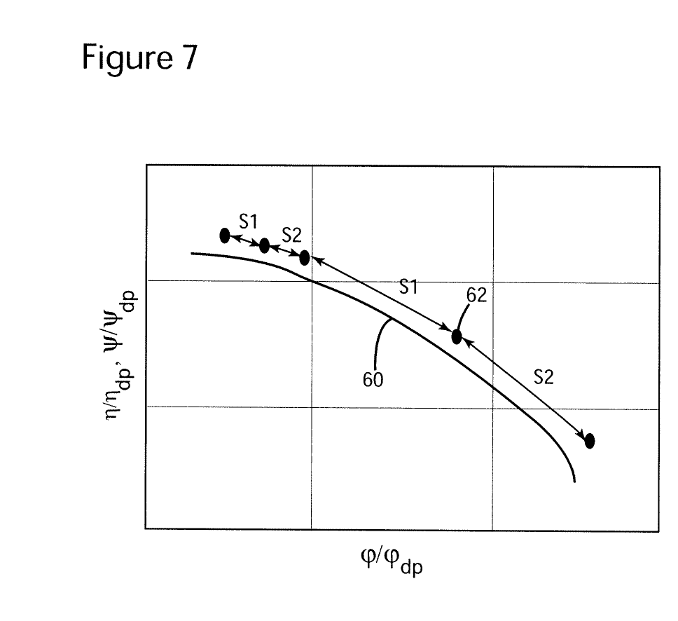

FIG. 7 illustrates in more details how one of the error component is calculated. S1 and S2 are distances between two adjacent points representing members of the same family. An integrated correction factor ‘p’ accounts for the uneven distribution of points and is given by p=(s1+s2)/2. A distance ‘d’ is defined as the normal distance between test data 62 and a prediction curve 60. For example, if two points (x0, y0) and (x1, y1) are present on the prediction curve 60 and one test point is between these two points and above them, the distance d is defined as d=[(y0−y1)(x2)+(x1−x0)(y2)+(x0y1−y0x1)]/sqrt[(x1−x0)̂2+(y1−y0)̂2]. Other definitions for the distance d may be used. The error is given by:

$$error = \frac{{\sum }_{n} p * w * \vert d \vert}{{\sum }_{n} p * w}$$

where n denotes the total number of test data, “*” denotes the multiplication operation, and w is the weight specified by the designer. If points 62 are farther away, the values of s1 and s2 are greater and hence the contribution of the p value to the error, Error, is higher compared to points that are located near to one another. For the first and the last point, the p value may be equal to either s1 or s2 alone. In this way, the optimizer handles evenly the uneven distribution of data points effectively. The optimizer is also capable of handling variable weights for individual points for the experimental data as defined by the user in the test data input file.

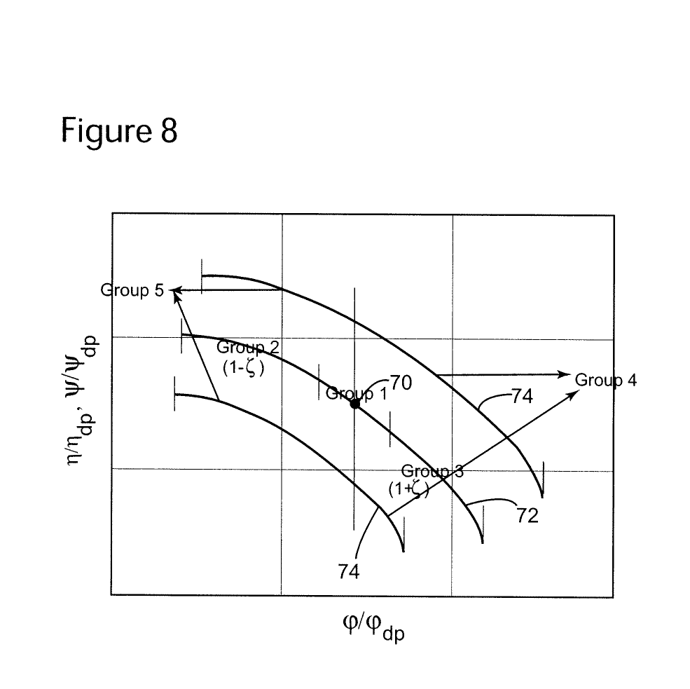

According to an exemplary embodiment, design and off design conditions may be handled separately by assigning them to different groups. The design point is the point having the characteristics intended for a certain compressor, e.g., speed 10,000 rpm at the intended mass flow. Off design points are points around the design point, e.g., varying mass flow but at the same speed, and points with both varying mass flow and speed. The design point 70 and other points on a desired speed curve 72 may be categorized into three groups: group 1 defined by parameters corresponding to flow ratio between (1+/−ξ), group 2 defined by parameters corresponding to flow ratio below (1−ξ), and group 3 defined by parameters corresponding to flow ratio above (1+ξ). If two off design speed lines are considered, assume for speeds ‘x’ and ‘y’, then parameters corresponding to flow ratio (1+ξ) of x and y are assigned to Group 4 and (1−ξ) to Group 5. This separation of the parameters indicates that each group can be considered individually depending on the requirement and user specification. FIG. 8 illustrates the above groups. FIG. 8 also shows the design point 70, the design speed curve 72, and the off-design speed curves 74.

According to an exemplary embodiment, the optimizer is configured to tune any number of tuning/calibration variables as specified by the user and any number of speed lines in one run. When changing the parameters, the optimizer is determining a smooth evolution of the parameters by, for example, defining a polynomial function (linear or quadratic or n^{th} order) across these parameters for the entire family. This novel feature allows the optimizer to more accurately determine tuning/calibration parameters for a new compressor. Also, the optimizer is determining a smooth evolution of the tuning/calibration parameters as close as possible to the default values by normalizing these values by the user specified bounds of the tuning/calibration variables and these normalized results are assigned to a specific factor. A deviation is calculated as the sum of all these factors. By minimizing the RMS value of the total Error and Devi, the tuning/calibration variables are tuned/calibrated as close as possible to the default criteria. In one application, the user may choose to relax the Devi factor in order to allow the tuning/calibration parameters to deviate more from the default values.

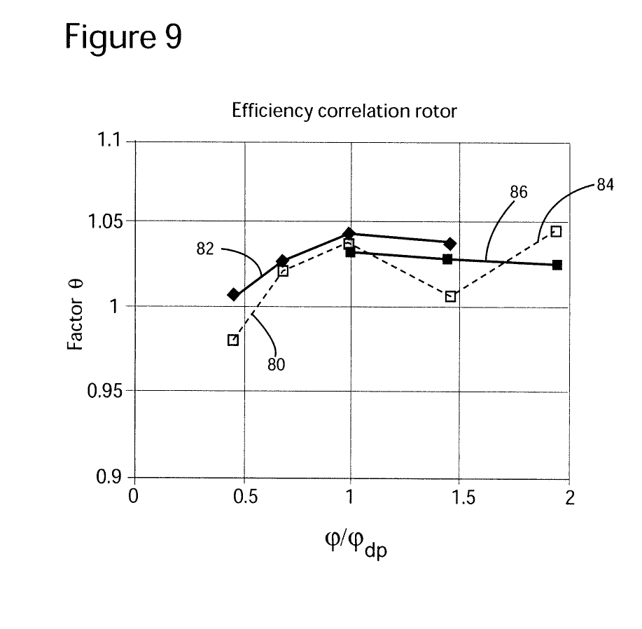

FIG. 9 shows the behavior of tuning/calibration parameters (efficiency correlation factor θ) calculated with the novel optimizer and manually for two different families F1 and F2. Family F1 calculation was performed with four masters and a quadratic parameter fit and Family F2 used three test masters and a linear parameter fit. Curve 80 indicates the manual calculation for Family F1 and curve 82 indicates the optimizer calculation for the same family. Curve 84 indicates the manual calculation for family F2 and curve 86 indicates the optimizer calculation for the same family. FIG. 9 illustrates the smooth evolution of the tuning/calibration parameter resulting from the family tuning/calibration performed by the optimizer versus the one that was manually tuned/calibrated. In addition, the optimizer performed family tuned/calibrated parameter is also closer to the default values than the manually tuned/calibrated parameter.

In an exemplary embodiment, the algorithm of the optimizer may start with a differential evolution (DE) genetic algorithm step, followed by a step that utilizes a simplex-based optimization algorithm (e.g., AMOEBA, Wang, L., and Beeson, D., 2003, “Non-Gradient Based Methods for probabilistic analysis”, 44^{th} AIAA/ASME/ASCE/AHS structures, structural dynamics, and materials conference, AIAA 2003-1782, the entire disclosure of which is incorporated herein by reference). The first step may involve a genetic algorithm (GA) method because of its robustness and global search capabilities. The second step may be based on the AMOEBA method, which is a local optimization method. This second step is used to expedite the process of arriving at a final optimum design once the most promising part of the design space is identified using the first GA-based step.

The GA method randomly generates the tuning/calibration variables. Therefore, the initial set of tuning/calibration variables are needed only for performance normalization. This random process of tuning/calibration variable generation may result in “unphysical-computations” which may cause the prediction tool to halt or crash. To resolve this issue, the optimization problem has been structured with higher penalty values for such situations thus ensuring the algorithm to be executed smoothly. Finally, the procedure may implement features such as removing any freezing run as a last resort to avoid any premature halt of the optimization process.

A modified objective function (OFMOD) is defined as the RMS value of the total error, Error, between predicted and experiment as well as the deviation Devi of the tuning/calibration variables from the default. More specifically, OFMOD is given by:

OFMOD=ΣError+W_devi*devi,

where Error and Devi have been introduced above. The objective function OF is defined as Minimize(OFMOD).

In one simulation performed by the inventors, seven tuning parameters were used to tune one set of four masters and one set with three masters, each with three speed lines. The variations in design were such that the largest design flow coefficient was approximately three times the smallest design flow coefficient. The optimization was performed for polytropic efficiency and head. The design point was given a 20 times weight compared to the off-design points and a devi factor of 5:1. The CPU time needed was approximately one week per set of masters comparative to two months for the traditional tuning.

The optimization algorithm was tested for standard centrifugal compressor stage family masters. The optimization process used seven tuning/calibration parameters to tune the four masters, three masters with three speed lines and one master with four speed lines. An initial set of tuning/calibration parameters may include either one set of default parameter values or tuning/calibration parameter values of other turbo-machineries from a similar family as the new turbo-machinery, or modified tuning/calibration parameter values with an allowed deviation from the default parameter values. Parameters that were tuned/calibrated in this particular case include but are not limited to two coefficients on the inlet flow, one coefficient in the impeller exit flow angle, a critical Mach number, one coefficient on the flow separation, one efficiency coefficient and one blockage coefficient. This also includes other performance tuning/calibration coefficients at the impeller (Splitter or Non Splitter in one or multiple rows), diffuser (with airfoil of low solidity or cascade or wedge type with one or multiple rows of vanes or without vanes) and return channel (one or multiple rows with splitter or cascade vanes or wedge type vanes), exit system (scroll, collector, deswirl) in a single or multi stage compressor configurations for a single stage master or for the entire compressor stage master families.

The modified objective function value represents the cumulative error considering all the masters and all the speed lines and the optimization algorithm was executed with the objective of minimizing the OFMOD and tuning/calibrating all the seven parameters simultaneously. An initial tuning/calibration was based on differential evolution type genetic algorithm for global optimization followed by a simplex-based procedure for capturing the local optimum solution. This procedure was able to reduce the objective function value by almost 80% compared to the baseline, the baseline being the default values of the tuning/calibration parameters.

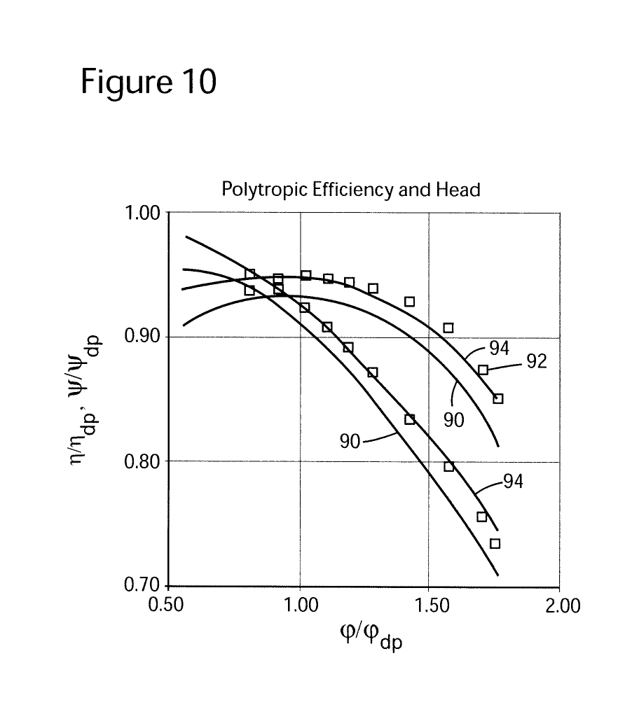

FIG. 10 illustrates the results of one of the four masters tuned/calibrated with respect to measured values at design speed. Values were normalized with respect to a baseline design point value in order to show the existence of differences between predicted and experimental values. It is noted that traditional values 90 are further away from experimental data values 92 than the optimized values 94. Also, it is noted that the curve shape of the optimized curves 94 better fit the test data than the traditional ones.

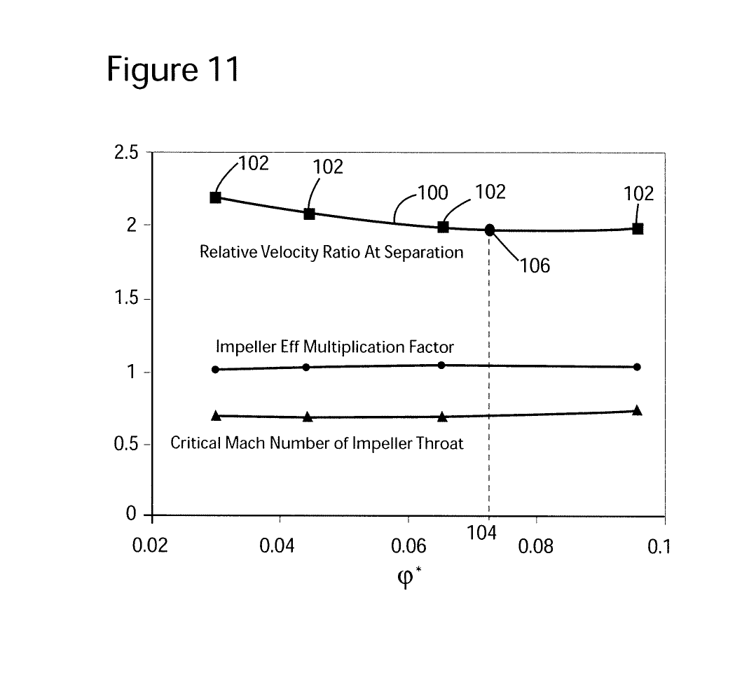

FIG. 11 shows that various tuning/calibration parameters 100 of the compressor family have a smooth evolution from member to member of the family after the novel optimizer has been applied. The parameter curves 100 shown in FIG. 11 contrast to the manual tuning/calibration results illustrated by curves 80 and 84 in FIG. 9. By achieving this high grade of smoothness, the novel optimizer produces a better database of compressors points and thus, when a new compressor is ordered by a customer, the interpolation process for calculating the characteristics of the new compressor produce better and more accurate results. The characteristic of a curve of being smooth may be described in terms of its first derivative. For example, consider that a tuning/calibration parameter for the entire family is described by curve 100 in FIG. 11. Curve 100 is considered to be smooth if a first derivative of the considered tuning/calibration parameter with regard to the flow coefficient for the entire family is continuous. It is noted that FIG. 11 shows points 102 that correspond to the master designs, i.e., those machines that have been tested and curve 100 represents the considered design parameter for the entire family. Thus, when a client desires a new turbo-machinery having a desired flow coefficient indicated by reference number 104, an operator of the database that includes curve 102 is able to quickly identify one or more design parameters 106 that correspond to the desired turbo-machinery.

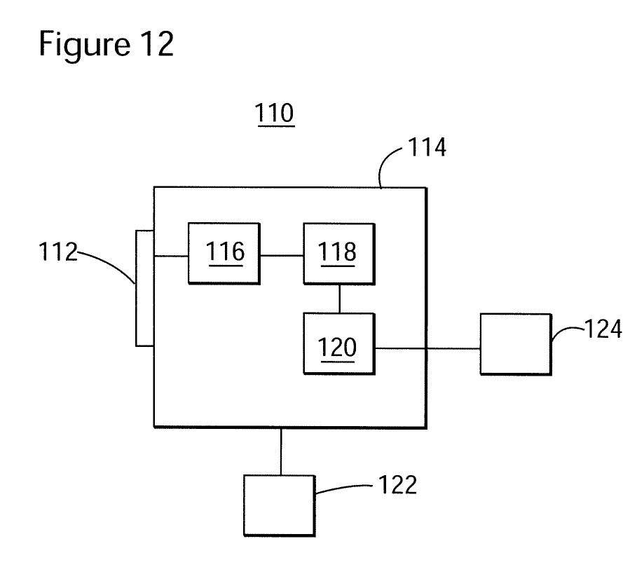

A design apparatus 110 for determining a set of tuning/calibration parameters for designing a new turbo-machinery is next described with regard to FIG. 12. The design apparatus 110 may include an interface 112 configured to input operating parameters of other turbo-machineries from a same family as the new turbo-machinery. For example, the interface 112 may be a keyboard, a mouse, a scanner, etc. Interface 112 is connected to a processor or dedicated circuitry (analog or digital) 114. Processor 114 may include various functional blocks. For example, processor 114 may include a first block 116 that is configured to calculate family turbo-machinery quantities based on the operating parameters received from interface 112. A calculation block 118 is configured to compare the calculated family turbo-machinery quantities with measured quantities and to calculate a first error (Error) between the calculated family quantities and the measured quantities. The same calculation block 118 may be configured to also calculate a second error (Devi) between tuning/calibration turbo-machine variables and default values of the turbo-machine variables. A logic block 120 is configured to form a modified objective function that includes both the first and second errors. The logic block 120 or another block is configured to determine the set of tuning/calibration parameters for the family to be smooth from one member to another member based on minimizing the modified objective function. The results of this operation may be stored in a database located in a memory 122. The memory may communicate with the processor 114 or may be located inside processor 114. A display unit 124 may be attached to the processor 114 and may be configured to display the tuning/calibration parameters. In one application, the design apparatus 110 may be a dedicated workstation that is configured to perform specific steps as discussed next.

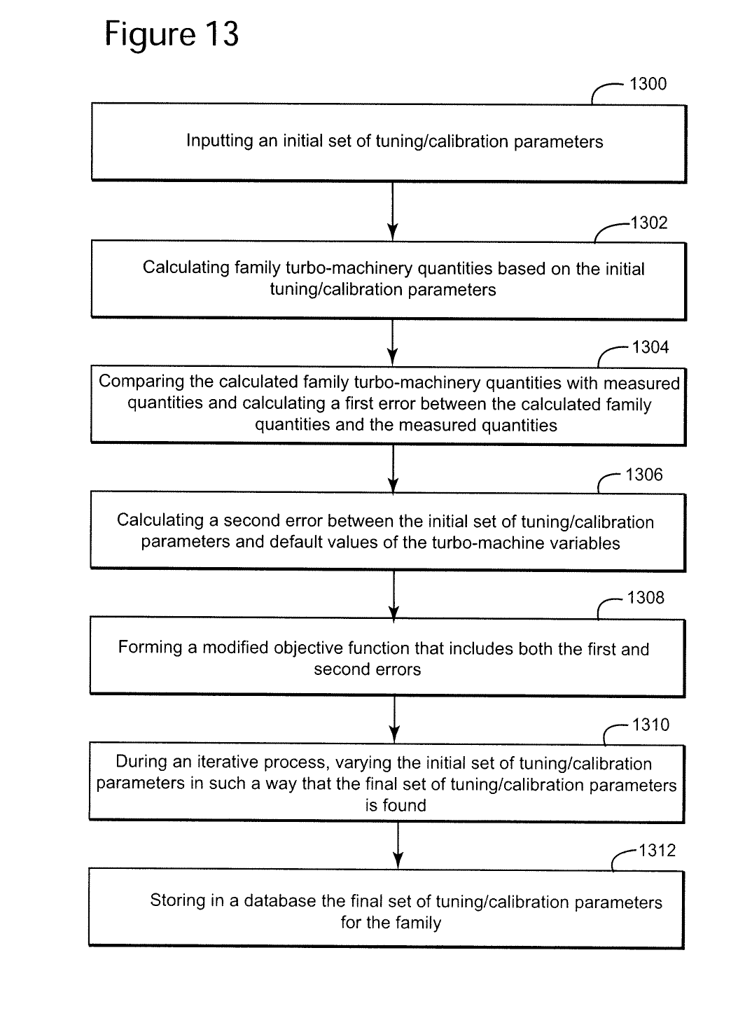

According to an exemplary embodiment, illustrated in FIG. 13, there is a method for automatically determining a final set of tuning/calibration parameters for designing a new turbo-machinery. The method includes a step 1300 of inputting an initial set of tuning/calibration parameters; a step 1302 of calculating family turbo-machinery quantities based on the initial set of tuning/calibration parameters; a step 1304 of comparing the calculated family turbo-machinery quantities with measured quantities and calculating a first error between the calculated family quantities and the measured quantities; a step 1306 of calculating a second error between the initial set of tuning/calibration parameters and default values of the turbo-machine variables; a step 1308 of forming a modified objective function that includes both the first and second errors; a step 1310 of varying, during an iterative process, the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and a step 1312 of storing in a database the final set of tuning/calibration parameters for the family.

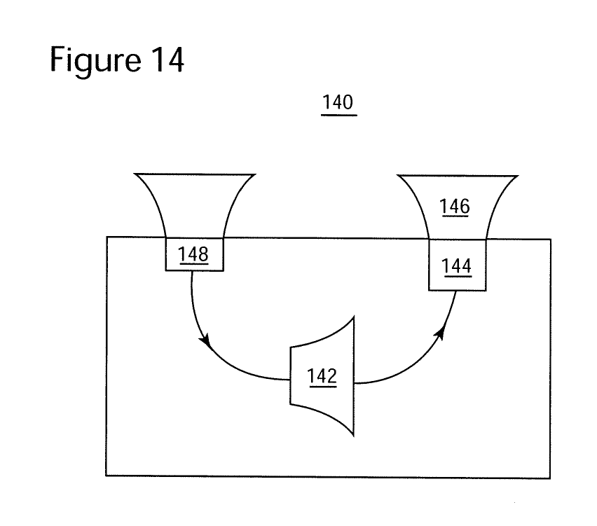

The above described method may be implemented in the design apparatus 110 show in FIG. 12. The design apparatus 12 may calculate tuning/calibration parameters for a centrifugal compressor. An exemplary centrifugal compressor is shown in FIG. 14. Centrifugal compressor 140 may include an impeller 142, a diffuser 144, an exit system 146, and an Inlet Guide Vane device 148.

The disclosed exemplary embodiments provide a system and a method for automatically determining a set of tuning/calibration parameters for designing a new turbo-machinery. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for automatically determining a final set of tuning/calibration parameters for designing a new turbo-machinery, the method comprising:
inputting an initial set of tuning/calibration parameters;
calculating family turbo-machinery quantities based on the initial set of tuning/calibration parameters;
comparing the calculated family turbo-machinery quantities with measured quantities and calculating a first error between the calculated family quantities and the measured quantities;
calculating a second error between the initial set of tuning/calibration parameters and default values of the turbo-machine variables;
forming a modified objective function that includes both the first and second errors;
during an iterative process, varying the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and
storing in a database the final set of tuning/calibration parameters for the family.

2. The method of claim 1, wherein the initial set of tuning/calibration parameters comprises either one set of default parameter values or tuning/calibration parameter values of other turbo-machineries from a similar family as the new turbo-machinery, or modified tuning/calibration parameter values with an allowed deviation from the default parameter values.

3. The method of claim 1, wherein a tuning/calibration parameter is smooth when a first derivative of the tuning/calibration parameter relative to a flow coefficient is continuous for the entire family.

4. The method of claim 1, wherein the measured quantities are measured for existing turbo-machineries of the family.

5. The method of claim 1, wherein the first error is a root mean squared (RMS) of a sum of normal distances between (i) each calculated family turbo-machinery quantity and (ii) a corresponding measured quantity.

6. The method of claim 1, wherein the second error is weighted when added to the first error.

7. The method of claim 1, wherein the final set of tuning/calibration parameters comprises one or more of two coefficients on an inlet flow, one coefficient of an impeller exit flow angle, a critical Mach number, one coefficient on a flow separation, one efficiency coefficient and one blockage coefficient.

8. The method of claim 1, wherein the new turbo-machinery is a centrifugal compressor having plural stages, an impeller, a diffuser, and an exit system.

9. The method of claim 1, wherein the turbo-machinery quantities comprise one or more of a polytropic efficiency, polytropic head, work coefficient, pressure ratio, surge, and choke limits.

10. The method of claim 1, further comprising:
applying a differential evolution genetic algorithm for minimizing the modified objective function.

11. The method of claim 10, further comprising:
randomly generating the initial set of tuning/calibration parameters.

12. The method of claim 10, further comprising:
applying a simplex-based optimization method for minimizing the modified objective function.

13. The method of claim 1, further comprising:
using a set of tuning/calibration parameters of the family to determine the final set of tuning/calibration parameters for the new turbo-machinery.

14. The method of claim 1, further comprising:
determining the final set of tuning/calibration parameters for a design point and off-design conditions.

15. A design apparatus for determining a final set of tuning/calibration parameters for a new turbo-machinery, the design apparatus comprising:
an interface configured to input an initial set of tuning/calibration parameters; and
a processor connected to the interface and configured to:
calculate family turbo-machinery quantities based on the initial set of tuning/calibration parameters;
compare the calculated family turbo-machinery quantities with measured quantities and calculate a first error between the calculated family quantities and the measured quantities;
calculate a second error between the initial set of tuning/calibration parameters and default values of the turbo-machine variables;
form a modified objective function that includes both the first and second errors;
during an iterative process, vary the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and
store in a database the final set of tuning/calibration parameters for the family.

16. The design apparatus of claim 15, wherein the initial set of tuning/calibration parameters comprises either one set of default parameter values or tuning/calibration parameter values of other turbo-machineries from a similar family as the new turbo-machinery, or modified tuning/calibration parameter values with an allowed deviation from the default parameter values

17. The design apparatus of claim 15, wherein a tuning/calibration parameter is smooth when a first derivative of the tuning/calibration parameter relative to a flow coefficient is continuous for the entire family.

18. The design apparatus of claim 15, wherein the measured quantities are measured for existing turbo-machineries of the family.

19. The design apparatus of claim 15, wherein the first error is a root mean squared of a sum of normal distances between (i) each calculated family turbo-machinery quantity and (ii) a corresponding measured quantity.

20. A computer readable medium including computer executable instructions, wherein the instructions, when executed, implement a method for automatically determining a final set of tuning/calibration parameters for a new turbo-machinery, the method comprising:
inputting an initial set of tuning/calibration parameters;
calculating family turbo-machinery quantities based on the initial set of tuning/calibration parameters;
comparing the calculated family turbo-machinery quantities with measured quantities and calculating a first error between the calculated family quantities and the measured quantities;
calculating a second error between the initial set of tuning/calibration parameters and default values of the turbo-machine variables;
forming a modified objective function that includes both the first and second errors;
during an iterative process, varying the initial set of tuning/calibration parameters in such a way that the final set of tuning/calibration parameters is found and the final set of tuning/calibration parameters achieves (1) a best fit between the family of turbo-machinery quantities and the measured quantities, and (2) a smooth transition for the final set of tuning/calibration parameters from one member to another member of the family; and
storing in a database the final set of tuning/calibration parameters for the family.
